(19) United States
(12) Patent Application Publication
(10) Pub. No.: US 2005/0076214 A1
(43) Pub. Date: Apr. 7, 2005

(54) Method and system for file downloads to portable computing devices

(76) Inventors: David Andrew Thomas, Atherton, CA (US); Edward H. Perry, Mt. View, CA (US); Sujata Banerjee, Sunnyvale, CA (US); Puneet Sharma, Palo Alto, CA (US); Amy Csizmar Dalal, Northfield, MN (US); Sung-Ju Lee, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/678,936

(22) Filed: Oct. 3, 2003

(51) Int. Cl. G06F 12/14; G06F 17/60

(52) U.S. Cl. 713/170; 713/187; 705/52

(57) ABSTRACT

The present disclosure allows for the downloading of large digital media files in a progressive manner by allowing for a transfer of such digital media to occur over various sessions. A file server is described that receives a request to transmit a file whereupon the file server locates such requested file in its memory. For verification purposes a unique identifier is computed for the requested file such as an MD5 checksum of the digital file. Thereafter an encryption key, K1, is chosen. Using a second key, K2, the first key and the unique identifier are encrypted, and the requested file is encrypted using the first key. Both these encrypted values are then transmitted. Subsequently, for example, after payment is received, an unencrypted form of the first key is also transmitted. The first key can then be used to decrypt the requested file to unlock full functionality of the requested file.

### FIELD OF THE INVENTION

The present invention relates to the field of communications systems. More particularly, the present invention relates to methods and systems for downloading digital information having, for example, audio and video information to portable computing devices.

### BACKGROUND

In certain mechanisms for buying media, the media selection operation is placed before a download is initiated. Such schemes suffer the disadvantage that until the user has made a choice, the file cannot be transferred. Moreover, in scenarios that involve the downloading of a large file in a constrained bandwidth environment, the time to download after the decision could be several or many minutes. Constrained bandwidth situations may exist, for example, in wireless networking situations or hotspot networking situations whereby accessible wireless networks are established in a region. In such environments, extended delays can be long enough that the user may not wish for the transfer to complete whereby a content provider loses a sales opportunity. Even if payment can be made prior to initiating a download, a user may nonetheless abort a file transfer that takes too long. With payment made and no useable content received, a user may not so readily make a purchase at a future opportunity thereby reducing the potential customer population—not a desirable result.

Presently, there exist systems for the downloading of files that do not make considerations for different content within a file. For example, digital movies can present much entertainment value to a user because it offers both video and audio stimulation. One component, either audio or video, without the other offers little if any value to a user. Indeed, it is the video component that comprises the largest part of a digital movie with the audio component being a very small percentage of the entire file. In prior art schemes, however, such audio and video components have been handled as part of a unitary digital movie file.

TIVO®, Inc., for example, provides a system for downloading movies, movie trailers and clips to a digital recording device. Because the TIVO® system does not operate in a time constrained scenario, combined digital and audio file transfers can occur over a long time. Thus, to handle audio and video in separate downloading schemes has not been necessary. Because of the wide bandwidth available through cable communications, large audio/video transfers can occur rapidly. Moreover, because a TIVO® system is not transitory in nature, it is not expected that the TIVO® system will lose communication during a file transfer.

Other systems, including the KONTIKI® DELIVERY MANAGEMENT SYSTEM (DMS) provided by KONTIKI®, Inc., allows the downloading of movies and other video content to home computers. Although, these systems may operate under some bandwidth constraints, as many home computer users access the Internet via slow dialup connections, they do not have prohibitive time constraints of other types of users including users of hotspots. Indeed, home computers may download content over several hours or days with a low expectation that a computer's connection to the Internet will not be interrupted. Contrastingly, users of hotspots can only be expected to be within a hotspot for a short time, often only minutes.

### SUMMARY OF THE INVENTION

The present teachings, however, allow for the handling of a digital movie with consideration of its audio and video components. Several schemes are described for handling a large file such as that of the video component of a digital movie. Where the video component is downloaded separately from an audio component, it can be downloaded over several sessions. Upon completion of the download of the video portion of a movie, however, it has limited value to a user. A movie's highest value is achieved when the audio component is also downloaded. Accordingly, a user can separately initiate the download of the corresponding audio component. Because the audio component is significantly smaller, its download can be achieved in a much shorter time, often in one hotspot session. Thus, several schemes can be implemented that provide video components to a user in a substantially transparent manner such that a user's perception of receiving the functionality of a digital movie essentially becomes the time required to initiate payment and download of a relatively small audio component.

According to an embodiment of the present teachings, a method is described for transferring files containing audio-video information. In such a method, a video component of the file is transferred to a device. Upon completing the transfer of the video component, a command is received from the device to transfer an audio component of the file. Thereafter, the audio component of the file is retrieved from a storage, and the audio component is transferred.

In another embodiment of the present teachings, an indication is received that a video component of the file resides in a user device. Thereafter, a command is received to transfer an audio component of the file. With such command, the audio component of the file is retrieved from a storage, and the audio component is transferred. In other implementations, encryption techniques are used. Also, schemes are implemented for receiving payment upon the completion of certain transfers.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a block diagram representing a large data file and how it can be progressively downloaded.

FIG. 2 is a block diagram of a system for transferring video and audio files.

FIG. 3 is a flow chart of a first method for transferring a file.

FIG. 4 is a flowchart of a second method for transferring a file.

FIG. 5 is a flowchart of a method for transferring a file upon entering a hotspot.

FIG. 6 is a flowchart of a method for encrypting and decrypting a file to be transferred.

FIG. 7 is a flowchart of a method for encrypting and decrypting a partially transferred file.

FIG. 8 is a method for payment for a transferred file.

FIG. 9 is a block diagram of a progressive encoding scheme.

FIG. 10 is a flowchart of a method for transferring a video and an audio portion of a file.

### DETAILED DESCRIPTION OF THE PREFERRED EMBODIMENTS

Among other things, the approach in accordance with the present teachings aid consumers in the download and purchase of digital content for use on mobile devices, including PDAs or other portable computing devices. Moreover, the present teachings can be used in hotspot situations to download digital information in a timely manner. A hotspot is, for example, a locale with an accessible wireless network, wherein hotspots may be distributed throughout a region. A hotspot may exist at a cafe or gas station for example. The present teachings can be applied to the downloading of all types of digital information and of various lengths. More particularly, the present teachings can be used for the downloading of audio/video content such as digitized movies. In an implementation, the present teachings are applicable to specially encoded digital media whose quality is improved as more information is downloaded.

Because users of hotspots may be transitory, it is important to provide users with content in a timely manner. Where the downloading of a file may take a time longer than the time spent at any one hotspot, the present teachings allow for the progressive download of a file. In this manner a large digital file is downloaded over various sessions at different hotspots. Where downloading of files is accomplished in a manner transparent to a user and where a user is only aware of the file when it is completely downloaded, a user essentially perceives the downloading of the file as substantially instantaneous. In fact, a user can obtain access to a file immediately upon choosing to access the file and confirming payment where use of the file is at a fee. Because of the transitory nature of users, a file transfer and payment must be achieved quickly or at least achieved in a user-perceived short time, e.g., within a few minutes.

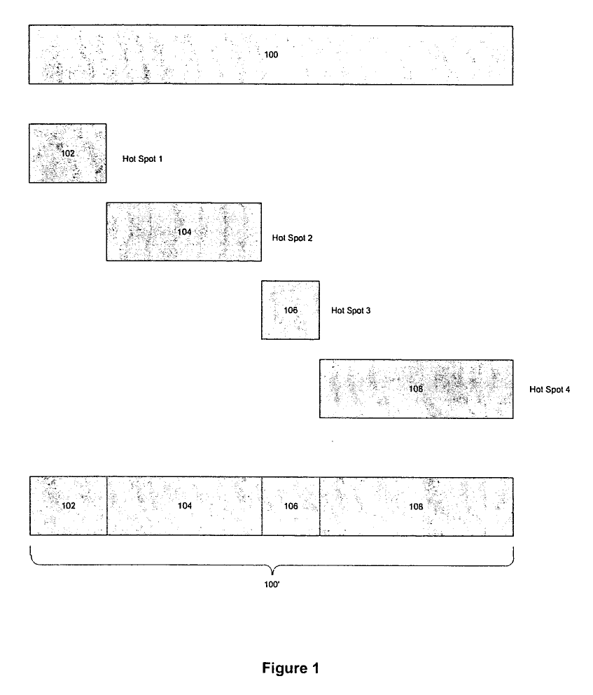

The present teachings are applicable for the progressive download of digital content. Indeed, progressive downloads can be particularly useful where a file of interest is large. In a progressive download scheme according to the present teachings, a large file, such as a game or audio/video file, can be progressively downloaded until the entire large file is completely downloaded. For example, shown in FIG. 1 is block 100 representing a large digital data file. According to the prior art a user needs to remain connected, such as to a wired or wireless network, for an extended period of time until the entire block 100 is downloaded. According to the present invention, however, block 100 can be progressively downloaded in smaller blocks. For example, as a user moves from one wireless access area, sometimes called hotspots, to another, a portion of the entire block 100 is progressively downloaded. As depicted in FIG. 1, block 102 is downloaded at Hotspot 1. For various reasons, less than the entire block 100 is downloaded while at Hotspot 1. This can occur because a user moves out of Hotspot 1, a user's battery is drained, or Hotspot 1 experiences a network failure. When at another hotspot, say additional Hotspot 2, a portion of block 100 may be downloaded, shown as block 104. Thus, the download process is not re-initiated, rather it progresses from the point at which a download was previously terminated. Similarly, as the user moves through other hotspots, e.g., Hotspot 3 and 4, further progressive blocks are downloaded such as blocks 106 and 108. As the individual blocks 102 through 108 are downloaded, they may be joined until the entire block 100′ is downloaded wherein block 100′ is substantially similar to block 100.

Where audio/visual information is desired, the file size of a digital movie is typically a few hundred megabytes with the majority of digital content devoted to video and a relatively small portion to audio. In fact, because audio and video portions may be handled separately, an implementation of the present teachings allows for the audio and video portions to be downloaded separately. Video portions may be downloaded at hotspots but may be downloaded before arriving at a hotspot also. For example, a user can download video portions for free at home or can obtain free video-only files from a rented DVD. While traveling, the user may then decide to pay for and download the corresponding audio potions when he desires entertainment and while at a convenient hotspot. Indeed, where the video portion is provided for free, a digital content provider gives a potential consumer an enticing opportunity for entertainment if a conducive situation arises, e.g., when the consumer becomes bored while traveling. In this context, many files can provide the user with entertainment such that a particular file need not be chosen a priori. Indeed, an element of serendipity in the selection of the file to transfer may add value as perceived by the user.

In another implementation, a checksum is used as part of identifying and authenticating a file. In such an implementation, a user can visit a specific web site and download checksums that correspond to media files of interest. Alternately, a user can identify media files of interest at a neutral third-party content site where checksums can be downloaded. Indeed, checksums can be intermediately downloaded onto a desktop computer and later loaded onto a PDA. With these authenticating checksums, directory service tasks to be described below can be simplified.

In another situation, files may be encoded with progressive quality such that a file may be usable even if it is only partially downloaded. For instance the audio and video content of a file may be encoded at multiple quality levels such that larger prefixes of the file are of better quality than smaller prefixes. Because prefixes of a file may contain meaningful progressively encoded content, an embodiment of the present invention enables the downloading of an entire content in several sessions and at multiple wireless access points.

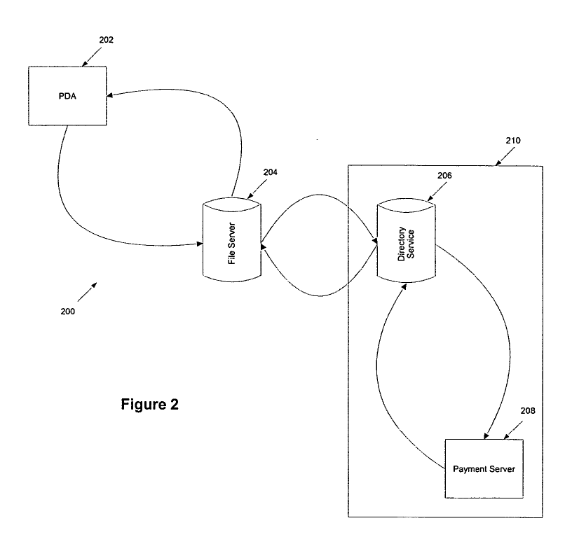

A system 200 according to the present invention is depicted in the block diagram of FIG. 2. As shown, system 200 includes a mobile computing device such as personal digital assistant (PDA) 202 which is configured with communications capabilities including wireless digital communication capabilities. In the discussion to follow the term “PDA” will be used to represent all matter of communications devices including wireless communications devices. PDA 202 can be a thin-client PDA with specialized functionality limited to practice at a minimum the present teachings. PDA 202 can also be a thick-client PDA with enhanced functionality including enhanced memory and processing capabilities. PDA 202 can also be a personal computer or a cellular telephone with appropriate memory and processing functions.

As shown in FIG. 2, PDA 202 is configured to wirelessly communicate with file server 204. File server 204 contains within it many multimedia files that can be made available to PDA 202 through file downloads. In an embodiment of the invention file server 204 is not authenticated by PDA 202 such that authentication is performed after the download is complete. In this way, untrusted file server 204 need not perform any authentication tasks at the beginning of a download.

Where authentication is not provided by file server 204, directory server 206 is configured to subsequently confirm the contents of a file downloaded from file server 204 to PDA 202. File authentication can be provided in various schemes such as through a challenge-response algorithm or an MD5 checksum routine. Further below, an MD5 checksum routine will be described, however, one of skill in the art will understand that many more methods for file authentication can be used. In an implementation of directory server 206, file authentication is provided after a file download has been completed, but in another implementation, file authentication is provided in advance of a file download.

Further shown in FIG. 2 is payment server 208 that is configured to accept and confirm payment from a user and subsequently release an appropriate decryption key that provides access to the downloaded file. In an implementation, directory server 206 and payment server 208 can be combined in a deployed system into directory/payment server 210. Furthermore, if file server 204 is a trusted file server, an implementation of the present teachings provides a protocol without need to ensure the integrity of a file transfer once complete.

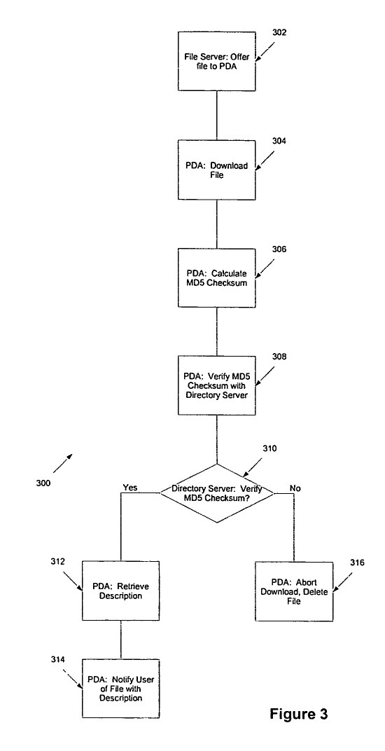

FIG. 3 is a flowchart of a method according to the present invention for downloading an unknown or unrequested file wherein file server 204 is untrusted and offers a file to PDA 202 at step 302 without making any declaration as to what the file may contain. PDA 202 downloads the file at step 304 and calculates the MD5 checksum at step 306. PDA 202 then contacts trusted directory server 206 at step 308. Upon verification of the checksum by directory server 206 at step 310, PDA 202 retrieves a human readable description from directory server 206 at step 312. The human readable description may be text such as a file or movie name or may some other unique or descriptive identifier. PDA 202 then notifies the user at step 314 that new content has been downloaded and is available for use. In an implementation, usage of the downloaded content is provided by a decryption key that is obtained through payment server 206 upon verification of the checksum at step 310. A link to such key could be provided in the downloaded file or in the returned result from directory server 206. Note that where directory server 206 cannot verify the checksum, the process terminates at step 316 by aborting and deleting the downloaded file from PDA 202.

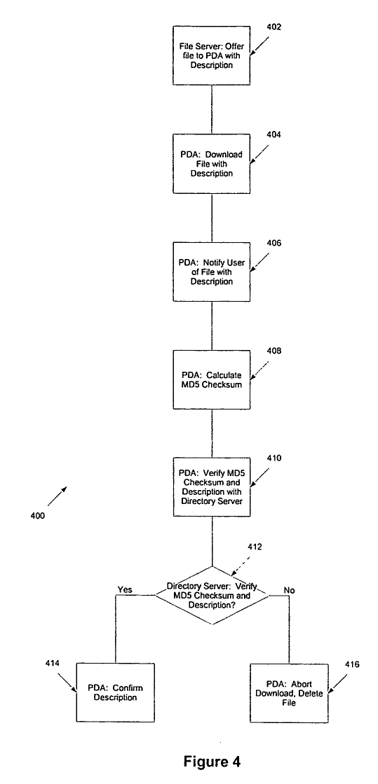

FIG. 4 is a flowchart of a method according to the present invention for downloading a known or requested file wherein file server 204 is untrusted and offers a file to PDA 202 at step 402 subsequent to PDA 202 identifying files or querying file server 204 for download. File server 204 can still be untrusted because PDA 202 is able to verify the checksum of the transferred file via directory server 206. PDA 202 downloads the file at step 404. Once downloaded, PDA 202 provides a description at step 406 of the downloaded file and further provides an indication that file is available for use. PDA 202 then calculates an MD5 checksum at step 408 that is used at step 410 to verify that the checksum and file description are what they purport to be. Directory server 412 verifies the checksum at step 412. Upon verification, the downloaded file is available for use at step 414. Note that where directory server 206 cannot verify the checksum, the process terminates at step 416 by aborting the download and deleting the file from PDA 202.

Once the file has been downloaded, payment can be made as will be described below. These scenarios show the utility of keeping the directory and payment servers separate. Method 400 is similar to method 300, but in method 400 file server 204 makes an assertion about the contents of the file, such as by transmitting a human-readable description of the file. In method 400, however, both the checksum and the textual description must be verified by directory server 206. An advantage is that a user can review and understand the description before contacting directory server 206.

In an implementation of the present teachings, PDA 202 is configured for wireless communication suitable for use at locales with wireless accessibility, e.g., hotspots. Moreover, a portion of its memory is configured for the storage of downloaded files, including aggressively-downloaded files (e.g., those files serendipitously downloaded from file server 204 to PDA 202). For proper operation, PDA 202 must therefore be able to identify a wireless access point and subsequently communicate with it. In an implementation of the present teachings, PDA 202 is configured to continually seek access points, and when one is encountered, PDA 202 is further configured to attempt to gain access to the network provided by such access point. Moreover, in an implementation of the present invention, upon finding an access point, PDA 202 invokes a DHCP protocol to acquire an IP address. PDA 202 can further be configured to obtain other networking information suitable for the access point, such as a default gateway.

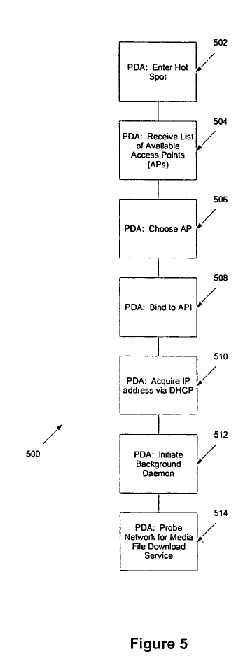

Shown in FIG. 5 is a flowchart for a method 500 by which a mobile device such as PDA 202 gains access to file server 204 through a wireless access point. As shown, method 500 is initiated at step 502 when PDA 202 enters a hotspot whereupon, at step 504, PDA 202 recognizes available access points (APs). Of these, PDA 202 chooses an AP at step 506. Having chosen an AP, PDA 202 binds to its associated channel at step 508. In an implementation of the present invention, PDA 202 acquires an IP address at step 510 via DHCP. PDA 202 then starts a background daemon at step 512 which probes the network for media file download service (step 514) such as provided by file server 204.

There are many ways in which PDA 202 can locate a media file server. For example, where the access point is using a private addressing scheme (such as 192.168.0.XXX), a predetermined address (e.g., 192.168.0.101) can be associated with a local file server. Also, a global name can be associated with a local file server, such as www.hpmediadownloads.com. A DNS service can then be responsible for binding such global name to a local address within the access point's address space such that the nearest file server 204 is identified. Either of these schemes allow for a determination of a server address or IP address of file server 204.

In an implementation of the present teachings, PDA 204 is further configured to issue an HTTP GET request to file server 204 for the contents of a virtual directory that identifies a file server's available files. In such an implementation, file server 204 can be further configured to generate an index of the corresponding files. Where a virtual directory is implemented, file server 204 can provide PDA 202 with a customized response to its query for available files.

Upon receiving a list of available files, PDA 202 can then choose to download a desired file. This process can be automated without need for user intervention such that PDA 202 can issue an HTTP GET request to the file server 204 for the desired file. Many protocols are appropriate for use with the present teachings including for example a file transfer protocol (FTP).

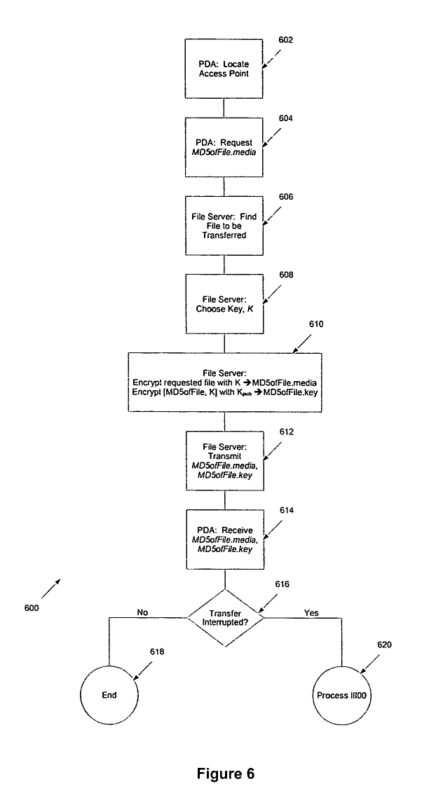

Because the present teachings allow a user to progressively download a media file in pieces from multiple locations, an encryption key used to encrypt the corresponding media file needs to be managed appropriately. Shown in FIG. 6 is a flowchart of a method 600 for handling encryption and decryption keys among PDA 202 and multiple file servers 204. Importantly, method 600 can simplify the backend system required for key generation and management. Moreover, method 600 allows for the possibility that hotspots might not always have an available communication path between one another to allow each media file key to be passed around from hotspot to hotspot. A further important aspect is that privacy is maintained because a user's identity need not be revealed in performing method 600.

In order to permit the same file to be downloaded from multiple locations, a common file identification can be employed. For example, file names can be based on the MD5 checksum of the file itself. Also, the MD5 checksum can be converted to an ASCII representation for readability. Moreover, a suffix can be appended to further identify the file. Importantly, the MD5 checksum ensures that the filenames are globally unique.

In method 600, two files are used. The first file is a file that contains the encrypted media, for example MD5ofFile.media. An unencrypted version of this file may contain a sequence of bits whose MD5 checksum is MD5ofFile. A second file contains the key used to encrypt the media file. The name of this file can be the same as that of the media file except for a different suffix, for example, MD5ofFile.key.

At step 602, PDA 202 locates an access point. Then at step 604, PDA 202 requests the file MD5ofFile.media. When the request is received, file server 204 locates the appropriate file to be transferred, that is the file whose MD5 checksum is MD5ofFile. Moreover, file server 204 chooses an appropriate key, K, at step 608. Because hotspot to hotspot communication is not presumed, method 600 provides for the transfer of the key, K, between hotspots without the need for back end communication. In an implementation, PDA 202 itself transfers an encrypted version of the key, K, between hotspots. To do this, each hotspot can have a public/private (e.g., K_{pub}) Kₚᵣᵢᵥ, respectively) that is distributed to each hotspot. In an implementation, such key pairs may remain constant, however, in yet another implementation, such key pairs may be changed periodically.

Thus, at step 610, file server 204 encrypts the requested file MD5ofFile with the chosen key, K, to generate MD5ofFile.media. Here, the chosen key, K, is unique to the particular transfer of the requested file such that the same requested file requested from the same or different hotspot at a different time will have a different chosen key, K. At step 610, file server then also encrypts the chosen key, K. In an implementation, the public key, Kpub, is used to encrypt the pair [MD5ofFile, K] to generate MD5ofFile.key.

At step, 612 file server 204 then transmits the encrypted files MD5ofFile.media and MD5ofFile.key to PDA 202. The files are then received by PDA 202 at step 614. The progress of the file transfer is monitored at step 616 by inquiring whether the file transfer is interrupted. Where no interruption occurs, the process continues until the entire file transfer is completed and the process ends at step 618. In the file transfer, the transfer of file MD5ofFile.media will likely be the one interrupted because it is the much larger file. Where the file transfer is interrupted, process 700 is initiated at step 620. The file transfer can be interrupted, for example, when a user leaves a hotspot or where a communication link is broken, among other reasons.

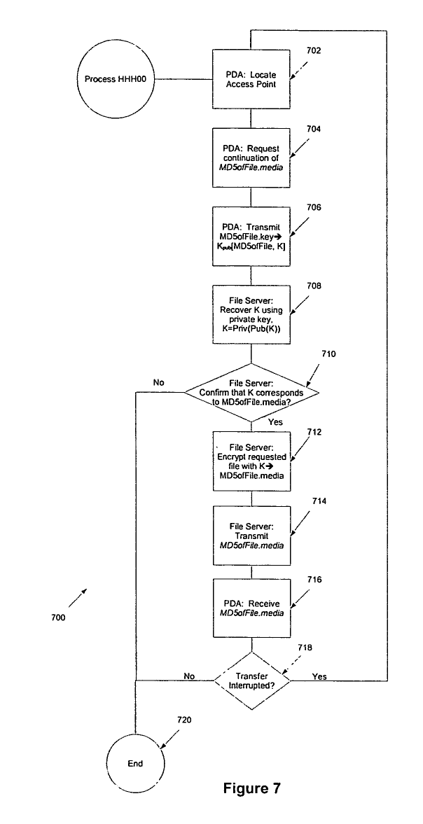

Shown in FIG. 7 is a flowchart for a method 700 by which PDA 202 continues to download a previously partially downloaded file upon identifying a new access point. PDA 202 can be configured to continually search for available access points such that at step 702, PDA 202 locates an access point. Here, the general case can be assumed where the located access point in method 700 is different from the access point of 600. Accordingly, the associated file server 204 can also be assumed to be different. Because PDA 202 already has part of a desired file, it requests continuation of such file, for example, MD5ofFile.media, at step 704. Recall that MD5ofFile.media is encrypted with key, K, but file server 204 associated with the present access point does not have such key, K. PDA 202, however, does have such information in the form of the encrypted file MD5ofFile.key. Thus, at step 706, PDA 202 transmits MD5ofFile.key to file server 204. With such transmitted information, file server 204 is then able to recover the key, K, as well as the MD5 checksum using its private key at step 708. File server 204 then confirms that the recovered key, K, actually corresponds to the desired file, MD5ofFile.media, at step 710 by matching the MD5 checksums. If the correspondence is not confirmed method 700 terminates at step 720. If the correspondence is confirmed, file server 204 can then encrypt the requested media file at step 712 and proceed to transmit at step 714 the remainder of the desired file in an encrypted form. PDA 202 then receives the desired file at step 714.

In a continuous manner, PDA 202 detects whether the desired file transfer is interrupted at step 716. Interruptions in file transfer can occur for many reasons, including loss of wireless connection, loss of power to PDA 202, loss of power to file server 204, memory errors, etc. Where an interruption occurs, method 700 can be reinitiated at step 702. That is, PDA 202 will look for an access point from which it can receive the remaining portion of the desired file. Where no interruption occurs, file transfer continues until the complete file is transferred and method 700 terminates at step 718.

In the application of methods 600 and 700 of FIGS. 6 and 7, respectively, certain steps have been described as being executed by certain devices, however, it should be noted that such steps may be performed by other devices without departing from the present teachings. For example, where certain tasks were described as being executed by file server 204, in another implementation certain of those steps may be performed by directory server 206 or payment server 208. Also, encryption tasks could be executed by directory server 206 or payment server 208.

In an implementation of the present invention, it can be possible for a misbehaving file server 204 to load PDA 202 with undesirable or unexpected content, such as pornography or malicious programs. This can be a problem especially where file server 204 is untrusted. But using a trusted directory server ensures that the user will know when the downloaded content is not the desired or expected content. Directory server 206 can use the MD5 checksum of a file as a verification of the contents of that file. An MD5 checksum is not a guaranteed verification, but for most applications it provides a substantial verification because it is impractical to falsify or forge an MD5 checksum of a file.

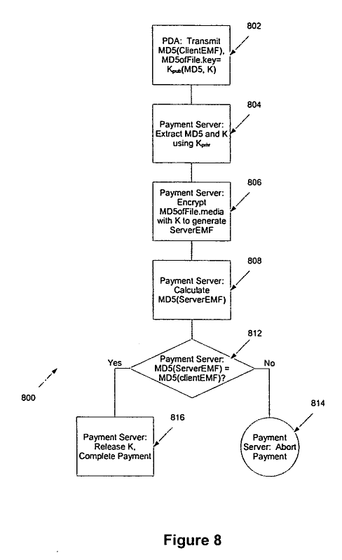

When downloading of a file is complete, directory server 206 can determine the authenticity of the downloaded file using method 800 of shown in FIG. 8. When the file transfer tasks of methods 600 or 700 are completed, directory server tasks are initiated at step 802 by PDA 202. Among its various tasks, directory server 206 maps MD5 checksums of files and their contents. Because the MD5 checksum is also used as the part of a filename, verification can be achieved by searching directory server 206 and locating an MD5 checksum for a media file of interest.

Recall that directory server 206, in order to provide its functionality, must be trustworthy. Accordingly, PDA 202 can make requests of file server 204 for files with an associated MD5-derived name which can then be authenticated by directory server 206. Because the contents of a file are encrypted and because the MD5 checksum covers the unencrypted file, the PDA cannot simply calculate the MD5 checksum over the received encrypted file to verify its contents. Moreover, for the file to be useful, the PDA must receive the decryption key, K, which is given to it by the payment server through the payment protocol of method 800. Thus, payment server 208 can also be used to verify that a file PDA 202 receives is in fact an encrypted version of the correct media file. Thus, in instances where file server 204 is untrusted, directory server 206, payment server 208 or the collective directory/payment server 210 can be used to build trust. Because payment server 208 must reveal the decryption key, K, it must have the public/private key pair, K_{pub}/Kₚᵣᵢᵥ, in order to allow payment server 208 to verify the MD5 checksum and reveal the decryption key, K.

Thus, at step 802, PDA 202 transmits MD5(ClientEMF), the MD5 checksum of the encrypted media file (EMF) it, as a client, has downloaded. At this step, PDA 202 also transmits the received MD5ofFile.key. Recall, MD5ofFile.key is derived from the K_{pub}[MD5; K] which can be decrypted by with the corresponding private key, Kₚᵣᵢᵥ. Accordingly, payment server 206 uses its private key, K_{Priv}, at step 804 to extract MD5 and K. At step 806, Payment server 208 encrypts the media file, MD5ofFile.media, with the obtained key, K, to produce server-calculated encrypted media file, ServerEMF. At step 808, payment server 208 calculates an MD5 checksum of ServerEMF, i.e., MD5(ServerEMF). Recall that at step 802, PDA 202 calculated and transmitted a ClientEMF such that at step 812, these two quantities, ServerEMF and ClientEMF, are compared. If the values are equal, it is confirmed that PDA 202 has downloaded the correct file. Accordingly, at step 816, payment server 208 releases the key, K, that allows PDA 202 to utilize the functionality of the downloaded file. If, however, confirmation fails at step 812, the payment process is aborted at step 814.

At such point, the unverified download can be deleted from PDA 202. Moreover, because PDA 202 likely has limited memory resources for the downloading of media files, a retention policy can be implemented wherein files are downloaded, but deleted according to a hierarchy. Factors that may affect such hierarchy include whether content was obtained at a cost or whether content is on a user's preference list, but the user declined to pay the fee. Files that are complete, but unknown to the user may be of lower priority; files that are not complete can also be of lower priority. Moreover, limitations may be placed on how long material may be retained.

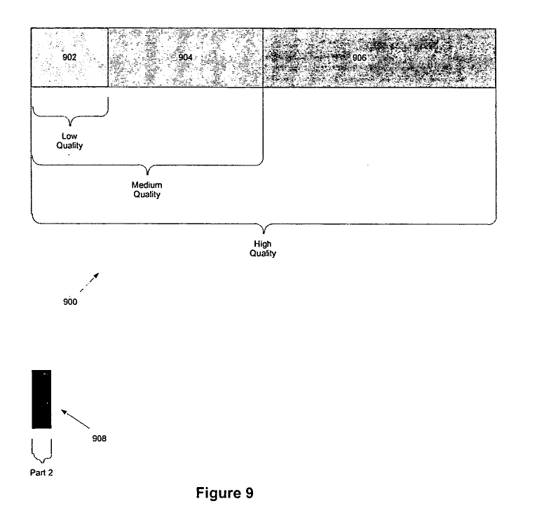

As discussed above, the present teachings are applicable for the progressive download of digital content, including the downloading of large files. In a progressive download scheme according to the present teachings, a large file, such as a game or audio/video file, can be progressively downloaded until the entire large file is completely downloaded. In certain situations, however, the present teachings can be used to progressively download files of progressive quality. For example, with reference to FIG. 9, block 902 is a graphical representation of digital media file of relatively low quality. Where the file of interest is an audio/video file, block 902 represents a digital media file with low video and/or audio quality. Accordingly, block 902 is a relatively small digital file that can be downloaded relatively quickly. Thus, after downloading the complete contents of block 902 in a relatively short time, the low quality audio/video file can be used.

If, however, a user desires higher quality content, he may choose to continue to download content until he has also downloaded block 904. Accordingly, after downloading both blocks 902 and 904, a user obtains a digital media file of relatively medium quality. Progressive quality schemes are presently available, for example, for video files. Thus, as more digital information is obtained, the quality of a digital media file can be improved. Where a digital media file contains different components, the quality of one or more such components can be improved separately. For example, the quality of a video portion may be improved while separately not improving the quality of an audio portion.

This progressive quality scheme can be implemented in several stages. As shown in FIG. 9, three levels of quality are shown wherein the high quality digital content is achieved by progressively downloading blocks 902, 904, and 906 to obtain the high quality digital block 900. Any number of stages can be implemented as appropriate for the digital content of interest.

As discussed, certain digital content is comprised of various components, for example, an audio and a video portion. In certain of these situations the various components can vary dramatically in size. For example, blocks 902, 904, and 906 can represent video content and block 908 can represent audio content where together they are audio/video content such as a digital movie. The size of block 908 is shown as substantially smaller than the video blocks to represent the real-world situation where even high quality audio content comprises much less digital information than even low quality video content. Indeed this situation is utilized in another aspect of the present invention.

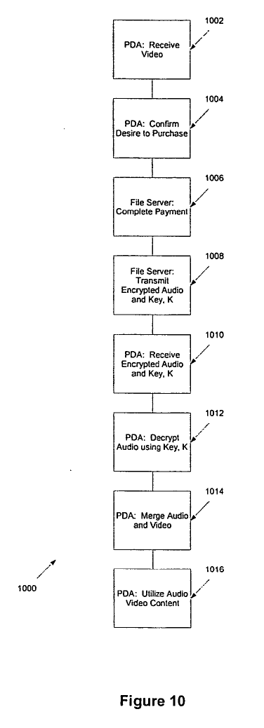

Shown in FIG. 10 is method 1000 for separately downloading video and audio content. In method 1000, large video content is downloaded according to the progressive download schemes of the present invention. Moreover, the video content can be downloaded in an unencrypted form thereby eliminating the need for the authentication protocols discussed above including the complex tasks of decryption a large file. In method 1000, however, a relatively small audio portion is downloaded separately upon confirmation that the user is interested in the complete audio/video file.

Method 1000 is initiated at step 1002 by downloading a video file, for example, using the progressive downloading methods describe above. A user, through PDA 202, then confirms a desire to purchase full access to the audio/video file at step 1004. At step 1006, file server 204 initiates the payment process, for example as described with reference to method 800. Upon confirmation of payment, file server 204 proceeds to transmit an encrypted audio portion and an encrypted key at step 1008. See method 800 for handling of such key. PDA 202 receives the encrypted audio portion and the encrypted key at step 1010. The key is then decrypted and further used to decrypt the audio portion at step 1012. With the separate audio and video portions, PDA 202 merges such portions at step 1014 for use at step 1016. At this point the combined audio/video file is available for use.

Note that even if the video portion of a file is downloaded without encryption, it is of little or no use to a user because the audio portion is missing. But, when payment is completed and the audio portion of relatively small size is transmitted, the combined audio/video file has much greater value to a user. Importantly, because the audio portion is relatively small, a user is not burdened to remain within a hotspot for an extended period thus maintaining a desirable spontaneity in purchasing digital content.

In instances where files are either downloaded over several sessions, or of variable quality, separate decryption keys can be established for each level of quality or portion of a file. Alternately, a same key can be used with an option to continue downloading the remainder of a file at a later time.

Among other things, the present teachings address the downloading of large files in environments where there is limited bandwidth and limited time available for the download to complete. For example, the present teachings are applicable to what has been called 802.11 hotspot networking. Moreover, the present teachings are applicable to the sale of digital media, including music and video, for which file sizes can be large even with state-of-the-art compression techniques. The present teachings enable the impulse or spontaneous purchases of digital media in a manner which permits substantially immediate gratification and access to media. In an embodiment of the invention, this is achieved through aggressive pre-downloading of digital content. Whereas certain embodiments have been described, one of skill in the art will understand that many variations are possible and indeed desirable.

1. A method for transferring files, comprising:
receiving a request to transfer a file;
locating the requested file stored in a memory;
computing a unique identifier corresponding to the requested file;
choosing a first key, K₁;
encrypting the first key, K₁, and the unique identifier with a second key, K₂, to generate a first value;
encrypting the requested file with the first key, K₁, to generate a second value; and
transferring the first and second values.

2. The method of claim 1, wherein the requested file is an encrypted file.

3. The method of claim 1, further comprising transferring the first key, K₁, upon a payment being made.

4. The method of claim 3, further comprising decrypting the second value with the first key, K₁, to generate the requested file.

5. The method of claim 1, further comprising interrupting the transmission of the second value.

6. The method of claim 5, further comprising continuing the transmission of the second value without retransferring the entire second value.

7. The method of claim 1, wherein the second key, K2, is a public key having a corresponding private third key, K3.

8. The method of claim 1, wherein the unique identifier is an MD5 checksum of the requested file.

9. The method of claim 1, wherein the unique identifier corresponds to binary information.

10. The method of claim 1, wherein the unique identifier corresponds to ASCII information.

11. A method for transferring files, comprising;
receiving a request to continue downloading a partially transferred encrypted file;
receiving a first value corresponding to an encrypted quantity wherein the quantity comprises a first key, K₁, and a first unique identifier corresponding to unencrypted form of the encrypted file;
recovering the first key, K₁, and the first unique identifier using a second key, K₂;
locating an unencrypted form of the encrypted file based on the first unique identifier;
computing a second unique identifier from the unencrypted form of the encrypted file;
confirming that the first and second unique identifiers are equal;
encrypting the unencrypted form of the encrypted file with the first key, K₁, to generate the requested encrypted file; and
transferring a remaining portion of the partially transferred encrypted file.

12. The method of claim 11, further comprising appending the transferred remaining portion with the partially transferred file.

13. The method of claim 12, further comprising transferring the first key, K₁, upon a payment being made.

14. The method of claim 13, further comprising decrypting the appended file with the first key, K₁.

15. The method of claim 11, further comprising interrupting the transmission of the remaining portion of the partially transferred encrypted file.

16. The method of claim 15, further comprising continuing the transmission of the remaining portion of the partially transferred encrypted file.

17. The method of claim 11, wherein the second key, K₂, is a public key having a corresponding private third key, K₃.

18. The method of claim 11, wherein the first and second unique identifiers are MD5 checksums.

19. The method of claim 11, wherein the unique identifier corresponds to binary information.

20. The method of claim 11, wherein the unique identifier corresponds to ASCII information.

21. A method for verifying downloaded files, comprising;
receiving a first unique identifier corresponding to a downloaded encrypted file, wherein the encrypted file was computed using a first key, K₁;
receiving a first encrypted value computed using a second key, K₂, wherein the encrypted value contains information relating to a second unique identifier and the first key, K₁;
extracting the second unique identifier and the first key, K₁, using a third key, K₃;
retrieving a third unique identifier corresponding to a verified file having the second unique identifier;
confirming that the first and third unique identifiers are equal; and
transferring the first key, K₁.

22. The method of claim 21, wherein the first, second, and third unique identifiers are MD5 checksums.

23. The method of claim 21, wherein the second key, K2, is a public key and the third key is a private key.

24. The method of claim 21, wherein the first, second, and third unique identifiers corresponds to binary information.

25. The method of claim 21, wherein the unique identifier corresponds to ASCII information.

26. The method of claim 21, further comprising decrypting the downloaded encrypted file using the first key, K₁.

27. The method of claim 21, further comprising locating an unencrypted form of the encrypted file based on the second unique identifier, computing an encryption of the located unencrypted form of the encrypted file with the first key, K₁, and computing the third unique identifier from the computed encryption.

28. An apparatus for transferring binary files, comprising:
means for receiving a request to transfer a file;
means for locating the requested file stored in a memory;
means for computing a unique identifier corresponding to the requested file;
means for choosing a first key, K₁;
means for encrypting the first key, K₁, and the unique identifier with a second key, K₂, to generate a first value;
means for encrypting the requested file with the first key, K₁, to generate a second value; and
means for transferring the first and second values.

29. The apparatus of claim 28, wherein the requested file is an encrypted file.

30. The apparatus of claim 28, further comprising means for transferring the first key, K₁, upon a payment being made.

31. The apparatus of claim 30, further means for comprising decrypting the second value with the first key, K₁, to generate the requested file.

32. The apparatus of claim 28, further comprising means for interrupting the transmission of the second value.

33. The apparatus of claim 32, further comprising means for continuing the transmission of the second value without retransferring the entire second value.

34. The apparatus of claim 28, wherein the second key, K2, is a public key having a corresponding private third key, K3.

35. The apparatus of claim 28, wherein the unique identifier is an MD5 checksum of the requested file.

36. The apparatus of claim 28, wherein the unique identifier corresponds to binary information.

37. The apparatus of claim 28, wherein the unique identifier corresponds to ASCII information.

38. An apparatus for transferring binary files, comprising;
means for receiving a request to continue downloading a partially transferred encrypted file;
means for receiving a first value corresponding to an encrypted quantity wherein the quantity comprises a first key, K₁, and a first unique identifier corresponding to unencrypted form of the encrypted file;
means for recovering the first key, K₁, and the first unique identifier using a second key, K₂;
means for locating an unencrypted form of the encrypted file based on the first unique identifier;
means for computing a second unique identifier from the unencrypted form of the encrypted file;
means for confirming that the first and second unique identifiers are equal;
means for encrypting the unencrypted form of the encrypted file with the first key, K₁, to generate the requested encrypted file; and
means for transferring a remaining portion of the partially transferred encrypted file.

39. The apparatus of claim 38, further comprising means for appending the transferred remaining portion with the partially transferred file.

40. The apparatus of claim 39, further comprising means for transferring the first key, K₁, upon a payment being made.

41. The apparatus of claim 40, further comprising means for decrypting the appended file with the first key, K1.

42. The apparatus of claim 38, further comprising means for interrupting the transmission of the remaining portion of the partially transferred encrypted file.

43. The apparatus of claim 42, further comprising means for continuing the transmission of the remaining portion of the partially transferred encrypted file.

44. The apparatus of claim 38, wherein the second key, K₂, is a public key having a corresponding private third key, K₃.

45. The apparatus of claim 38, wherein the first and second unique identifiers are MD5 checksums.

46. The apparatus of claim 38, wherein the unique identifier corresponds to binary information.

47. The apparatus of claim 38, wherein the unique identifier corresponds to ASCII information.

48. An apparatus for transferring binary files, comprising;
means for receiving a first unique identifier corresponding to a downloaded encrypted file, wherein the encrypted file was computed using a first key, K₁;
means for receiving a first encrypted value computed using a second key, K₂, wherein the encrypted value contains information relating to a second unique identifier and the first key, K₁;
means for extracting the second unique identifier and the first key, K₁, using a third key, K₃;
means for retrieving a third unique identifier corresponding to a verified file having the second unique identifier;
means for confirming that the first and third unique identifiers are equal; and
means for transferring the first key, K₁.

49. The apparatus of claim 48, wherein the first, second, and third unique identifiers are MD5 checksums.

50. The apparatus of claim 48, wherein the second key, K2, is a public key and the third key is a private key.

51. The apparatus of claim 48, wherein the first, second, and third unique identifiers corresponds to binary information.

52. The apparatus of claim 48, wherein the unique identifier corresponds to ASCII information.

53. The apparatus of claim 48, further comprising means for decrypting the downloaded encrypted file using the first key, K₁.

54. The apparatus of claim 48, further comprising means for locating an unencrypted form of the encrypted file based on the second unique identifier, means for computing an encryption of the located unencrypted form of the encrypted file with the first key, K₁, and means for computing the third unique identifier from the computed encryption.
